(19) United States
(12) Patent Application Publication
(10) Pub. No.: US 2007/0119481 A1
(43) Pub. Date: May 31, 2007

(54) Dishwasher with variable heat damping

(75) Inventor: Helmut Jerg, Giengen (DE)

Correspondence Address: Russell W. Warnock;BSH Home Appliances Corp, 100 Bosch Blvd, New Bern, NC, 28562, US

(73) Assignee: BSH Bosch und Siemens Hausgerate GmbH, Munich (DE)

(21) Appl. No.: 10/575,035

(22) PCT Filed: Oct. 8, 2004
(86) PCT No.: PCT/EP04/11273

§ 371 Date: Apr. 7, 2006

(30) Foreign Application Priority Data
Oct. 9, 2003 (DE) 10346964.8

(51) Int. Cl. B08B 9/20; B08B 3/00

(52) U.S. Cl. 134/25.2; 134/56 D; 134/58 D; 134/26

(57) ABSTRACT

A drying device enables the moist dishwashing items located in the washing container to be dried quickly in hygienic and economically viable conditions. The dishwasher has a washing container that is at least partially surrounded by a heat damping layer with variable heat conductivity that can be adjusted according to two different heat-conducting values. The variable heat damping layer can be adjusted during the dishwashing process in such a way that the heat conductivity thereof is only slight, whereby the heat energy building up on the washing container is maintained, for example, and the drying process can be adjusted, for example, in such a way that the heat conductivity thereof is high, whereby the heat energy is allowed to diffuse outwards from the washing container into the surrounding area.

The invention relates to a dishwasher with variable heat damping and a method for operating the same.

One or a plurality of washing containers to accommodate the items to be washed are usually provided in dishwashers. During the washing operation one or a plurality of washing processes are usually carried out to clean the items for washing located in the dishwasher. To enhance the cleaning effect the washing liquid is heated by means of electrical heaters before or during a rinsing process. The last washing process is usually followed by a clear rinsing phase followed by a drying process to dry the washed items.

For example, the washed items can be dried by own-heat drying using a heat exchanger by heating the rinsing liquid for the clear rinsing and thus the washed items which have undergone a hot clear rinse are dried by themselves using the self-heat of the washed items which has thus built up during the drying process. In order to achieve this own-heat drying, the clear rinsing liquid is heated to a certain temperature in the heat exchanger and applied to the washed items by means of spraying devices. As a result of the relatively high temperature of the clear rinsing liquid of usually 65° C. to 70° C., it is achieved that a sufficiently large quantity of heat is transferred to the washed items so that water adhering to said washed items evaporates as a result of the heat stored in said washed items.

All the washing program sections for heating, cleaning and drying items for washing in dishwashers described above are consequently frequently associated with the supply or removal of thermal energy into or out from the washing container of the dishwasher. Known dishwashers thus have a heat insulating layer which at least partly surrounds the washing container to preserve the thermal energy built up in the washing container during the washing process and thus reduce the energy requirement. In addition, the noise level is also reduced by this measure.

During the drying process however, it is desirable to be able to specifically reduce the thermal energy present in the washing container in order to remove moisture as rapidly as possible from the moist air mixture located in the washing container during the drying phase and thereby accelerate the drying phase. A disadvantage of the heat insulating layers according to the prior art is thus that thermal energy is also prevented from escaping from the washing container during the drying process.

In some known dishwashers cool external air is fed into the washing container during the drying process to improve the drying performance. It has proved disadvantageous in these dishwashers that the introduction of external air is unsuitable for hygiene reasons and the supply of external air into the washing container always involves a partial escape of the moist warm air located in the washing container which can result in mould formation in the surroundings of the dishwasher.

It is thus the object of the invention to provide a dishwasher which allows the wet washed dishes located in the washing container to be dried quickly from an economic and hygienic point of view. A further object of the present invention is to provide a method for operating a dishwasher which allows the dishwasher to operate as efficiently as possible from the energy point of view.

These objects are solved by the dishwasher according to the invention having the features of claim 1 and by a method for operating the dishwasher according to the invention having the features according to claim 14. Advantageous further developments of the invention are characterised in the dependent claims 2 to 13 and 15 to 18.

A dishwasher according to the present invention comprises at least one washing container and a heat damping layer which at least partially surrounds the washing container wherein the heat damping layer has a variable thermal conductivity which can be adjusted to at least two different thermal conductivity values. By this means, on the one hand the heat damping layer can be adjusted for example during the washing operation so that it has a lower thermal conductivity and thus the thermal energy built up in the washing container is preserved. On the other hand, during the drying process the heat damping layer can be adjusted for example so that it has a high thermal conductivity and thereby allow diffusion of the thermal energy from the washing container outside to the surroundings.

The present invention is consequently based on the principle of reducing the air humidity present in the washing container during the drying process by the moisture present in the washing container being deposited on the cool wall of the dishwasher. The cooling of the wall of the washing container is achieved by specifically increasing the thermal conductivity of the variable heat damping layer at least partially surrounding the washing container during the drying process. In this way, the removal of the thermal energy built up in the washing container through the wall of the washing container and the variable heat damping layer to the surroundings is specifically increased during the drying process. The dishwasher according to the invention with the variable heat damping layer thus has the advantage that both the drying time and the energy expenditure required for drying the washed items is reduced.

The dishwasher according to the invention also has the advantage that no moisture-laden air is delivered to the surrounding atmosphere, thus avoiding harmful influences on the furniture e.g. mould formation. Furthermore, the washed items do not come in contact with the external air during drying so that a high standard of hygiene can be ensured. In addition to the advantages of energy saving, the loading on the washed items are lower as a result of the reduction in the temperature of the clear rinsing liquid so that the risk of hairline cracks in ceramic crockery or earthenware vessels is reduced for example.

The aforementioned principle is based on the fact that the wall of the washing container has a lower temperature than the air located in the washing container by switching the variable heat damping layer to a high thermal conductivity so as to ensure good heat transfer from the interior of the washing container through the variable heat damping layer to the surroundings. In this case, the thermal conductivity of the variable heat damping layer is varied and regulated electrically and without mechanical means as will be described in detail hereinafter.

The heat damping layer of the dishwasher according to the invention contains an evacuable material having a comparatively coarse pore structure which changes its thermal conductivity more strongly than nano- or microstructured substances in the event of small vacuum pressure fluctuations. This property can be used to produce a variable heat damping layer which can be adjusted as required between a heat-conducting state having a k value of about 10 W/m²K and a highly insulating state having a k value of about 0.3 W/m²K. When the variable heat damping layer is in a state with a low k value and therefore low thermal conductivity, it has a heat insulating effect and keeps the thermal energy built up in the washing container stored. When the variable heat damping layer is in a state with a high k value and therefore high thermal conductivity, it has a heat conducting effect and allows the thermal energy built up in the washing container to diffuse through the wall of the washing container and the variable heat damping layer outside to the surroundings.

In a preferred embodiment of the dishwasher according to the invention, the variable heat damping layer comprises a closed capsule containing hydrogen in which at least one metal hydride grid is located which can form a chemical compound with the hydrogen and thus binds the hydrogen. The capsule surrounding the glass fibre core is formed from a gastight jacket preferably made of stainless steel sheet and is evacuated to an internal pressure of about 0.01 mbar at room temperature. Electrical heating means are preferably provided by which means the capsule of the heat damping layer can be heated up to a temperature of about 300° C.

Switching over the variable heat damping layer is effected by applying an electric current to the electrical heating means whereby the capsule is heated to a temperature of about 300° C. The heating of the capsule has the effect that the hydrogen previously bound in the metal hydride grid is released. The hydrogen thus released then diffuses in the entire glass fibre core of the heat damping layer and thereby increases the internal pressure of the capsule from about 0.01 mbar to about 50 mbar.

As a result of the increase in the internal pressure and as a consequence of the release of the hydrogen in the capsule, its k-value also increases, i.e. the thermal conductivity of the capsule or the entire heat damping layer. On the other hand, a cooling of the capsule of the variable heat damping layer has the effect that the free hydrogen forms a chemical compound with the metal hydride grid and is thereby resorbed. This has the consequence that the pressure in the capsule of the variable heat damping layer drops and as a result the thermal conductivity of the capsule or the entire heat damping layer is reduced. As a result of the pressure reduction in the capsule of the variable heat damping layer, its k-value also decreases, i.e. the thermal conductivity of the capsule or the entire heating damping layer. As a result of the chemical-physical processes described, the capsule of the variable heat damping layer has an internal pressure of about 0.01 mbar at room temperature whilst an internal pressure of about 50 mbar prevails in the capsule at a temperature of about 300° C.

The adjustment of the thermal conductivity of the variable heat damping layer therefore involves purely chemical-physical effects which take place without mechanically moving parts and are brought about merely by applying an electric current. These processes whereby the k value of the variable heat damping layer can be varied approximately by a factor of 40, can be repeated at least several thousand times in a heat damping layer. In this case, the thermally induced expansion at the edge of the variable heat damping layer can be up to 1 cm which should be taken into account in the choice of frame construction in the dishwasher according to the invention.

In a further preferred embodiment of the dishwasher according to the invention, the power of the current applied to the electrical heating means can be regulated continuously so that the thermal conductivity of the variable heat damping layer can also be adjusted continuously to an arbitrary thermal conductivity value between two thermal conductivity limits. For the purposes of the present invention good results can be achieved if the current applied to the electrical heating element can further be selected so that in the capsule of the variable heat damping layer any arbitrary pressure between about 0.01 mbar and 50 mbar is produced and thus the thermal conductivity of the variable heat damping layer can be adjusted to an arbitrary thermal conductivity possibly in the range between 0.3 W/m²K and 10 W/m²K.

A plurality of variable heat damping layers can be provided on the washing container of the dishwasher according to the invention where the dimensions of the individual heat damping layers are preferably selected so that they substantially each correspond to the area of the wall or top surrounding the washing container. The dimensions of a variable heat damping layer accommodated in the top of the washing containers can for example be 90×90×2 cm³. The variable heat damping layer can be disposed in one side wall or in the door of the dishwasher. It is also possible to accommodate a variable heat damping layer in the top, the bottom or in the back of the washing container but the side wall and the door of the dishwasher are especially suitable since these generally have an exposed layer and thus provide efficient heat removal. The more the washing container is surrounded by variable heat damping layers, the better the influence on the energy-saving effect of the dishwasher according to the invention.

During washing operation the variable heat damping layer can be adjusted to a low thermal conductivity so that substantially no heat transfer takes place through the variable heat damping layer so that the interior of the washing container is thermally insulated from the surroundings and therefore as little thermal energy as possible is delivered from the washing container to the surroundings. This has the advantageous effect that the energy expenditure for producing the heat required during the washing process is kept as low as possible.

During the drying process on the other hand, it is desirable to produce good heat conduction from the interior of the dishwasher to the surroundings. For this purpose, in a preferred embodiment of the dishwasher according to the invention, the variable heat damping layer is in heat-conducting contact with the interior of the washing container and with the outer wall of the dishwasher. Since the outer walls of the dishwasher generally consist of a metal housing, the housing of the dishwasher is especially well suited as a cooling surface. This promotes good heat transfer from the interior of the washing container to the surroundings of the dishwasher. In this way, the largest possible temperature difference between the moist warm air contained in the washing container and the wall of the washing container used as a condensing surface and therefore the most efficient possible condensation effect is achieved during the drying process.

In addition, the wall of the washing container bounding the interior of the washing container can be constructed as least partly as a condensing surface of flexible material, preferably in the form of a plastic or metal film, especially of aluminium. More appropriately, the water deposited in the washing container during the drying process is led from the washing container, for example, into the sump of the dishwasher or via the discharge pump from the dishwasher.

The aforesaid objects are further solved according to the present invention by a method for cleaning and drying items for washing in dishwashers comprising at least one washing container which is at least partly surrounded by a variable heat damping layer whose thermal conductivity can be adjusted to at least two different thermal conductivity values, where the dishwasher is capable of executing one or more washing programs comprising the following steps, that in a first section of the washing program thermal energy is built up in the washing container by heat generating means and at the same time the heat damping layer is adjusted to a low thermal conductivity so that the thermal energy built up in the washing container is substantially preserved in the washing container, and in a second section of the washing program a drying process is carried out wherein the heat damping layer is adjusted to a high thermal conductivity so that at least some of the thermal energy present in the washing container is delivered to the surroundings through the heat damping layer.

The method according to the invention offers the advantage that during the drying process the air moisture present in the washing container is reduced by the moisture in the air located in the washing container being deposited on the cool wall of the washing container. For this purpose the thermal conductivity of the variable heat damping layer at least partly surrounding the washing container is specifically increased during the drying process, promoting the delivery of the thermal energy built up in the washing container through the wall of the washing container and the variable heat damping layer to the surroundings. In this way, both the drying time and the energy expenditure required for drying the washed items is reduced. During the washing operation the variable heat damping layer according to the invention is adjusted so that it has a low thermal conductivity and thus the thermal energy built up in the washing container is preserved. The energy expenditure required for the washing operation is thereby reduced. In this case, the thermal conductivity of the variable heat damping layer is varied or regulated electrically without mechanical means, as has already been described in detail above.

In a preferred embodiment of the method according to the invention, before or during a washing process, a clear rinsing process or during a first section of the drying process the variable heat damping layer is adjusted to a low thermal conductivity with low k value and thermal energy is built up in the washing container by heat generating means, and during the drying process or during the second section of the drying process the variable heat damping layer is adjusted to a high thermal conductivity.

More appropriately, the thermal conductivity of the variable heat damping layer is regulated by the program control of the dishwasher. Since, as has been described above, the thermal conductivity of the variable heat damping layer depends on the temperature of the variable heat damping layer and this is determined by the operation of the preferably electrical heating means used to heat the variable heat damping layer, the thermal conductivity of the variable heat damping layer can be simply adjusted by regulating the heating means.

In a further preferred embodiment of the method according to the invention, the water deposited during the drying process in the washing container is passed from the washing container for example into a sump of the dishwasher and/or is conveyed from the dishwasher via the discharge pump. The drying performance of the dishwasher according to the invention can thereby be further increased.

The present invention is explained in detail using a preferred exemplary embodiment with reference to the appended drawings. In the figures:

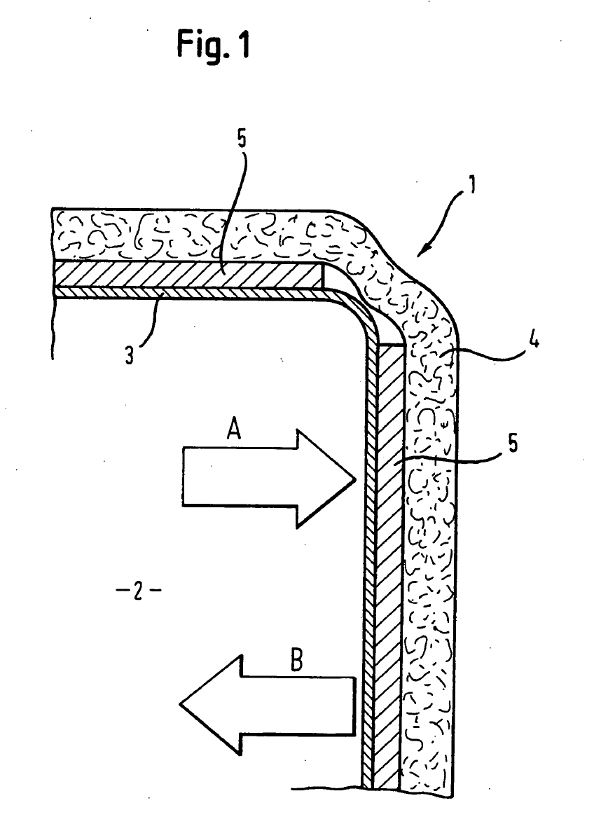

FIG. 1 is a sectional view of a dishwasher according to the invention with a variable heat damping layer during washing operation; and

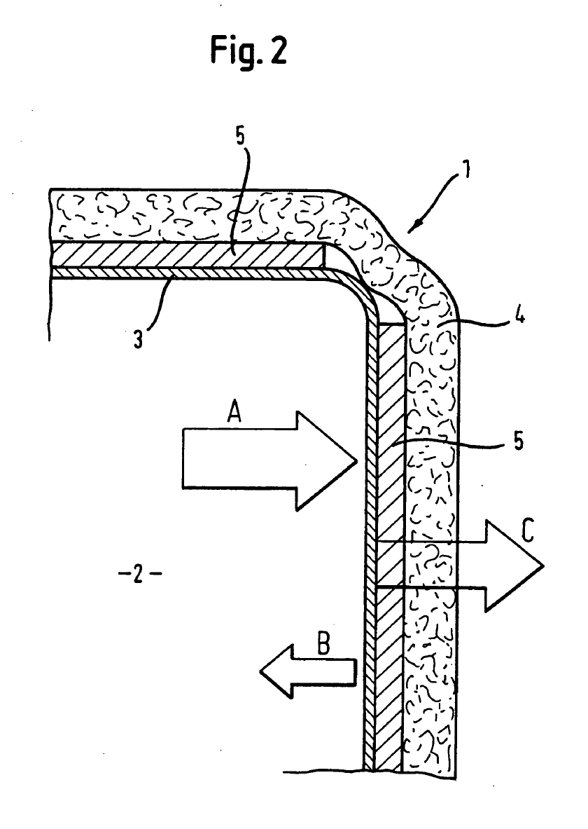

FIG. 2 is a sectional view through the dishwasher shown in FIG. 1 with a variable heat damping layer during drying operation.

FIG. 1 shows the washing container 1 of a dishwasher according to the invention during washing operation in a sectional view, where only part of the washing container is shown for better clarity. The dishwasher according to the invention has a washing container 1 whose interior 2 is bounded by an inner wall 3. The washing container 1 is further surrounded by another layer 4 which preferably consists of bitumen with sound-damping properties. Located between the inner wall 3 and the bitumen layer 4 is a variable heat damping layer 5. In the embodiment of the present invention shown in the drawings variable heat damping layers are disposed at least in the top and in the side walls of the washing container. Alternatively, the layer 5 can consist of bitumen and the layer 4 can be constructed as a variable heat damping layer.

The variable heat damping layers are distinguished by a heat damping property which can be varied and adjusted by means of a hydrogen technology. The heat damping layer contains an evacuable material whose thermal conductivity varies substantially in the event of small vacuum pressure fluctuations. This effect is used by the present invention to produce a variable heat damping layer which can be adjusted as required between a heat-conducting state with high k value and a highly insulating state with a low k value.

In a preferred embodiment of the dishwasher according to the invention the variable heat damping layer comprises a closed capsule (not shown) containing hydrogen in which at least one glass fibre core and one metal hydride grid (not shown) are arranged where the metal hydride grid can form a chemical compound with hydrogen and therefore bind the hydrogen. The capsule surrounding the glass fibre core consists of a gastight jacket of stainless steel sheet and is evacuated to a pressure of about 0.01 mbar at room temperature. The capsule of the variable heat damping layer can be heated by electrical heating means (not shown) to a temperature of about 300° C.

The thermal conductivity of the variable heat damping layer is varied by applying an electric current to the electrical heating means having a power of about 5 Watts whereby the capsule is heated to a temperature of about 300° C. The heating of the capsule causes the hydrogen previously bound in the metal hydride grid to be released. The hydrogen thus released diffuses in the entire glass fibre core and thereby increases the internal pressure of the capsule from about 0.01 mbar to about 50 mbar.

During washing operation the variable heat damping layer 5 is adjusted by the processes described above so that it has a low thermal conductivity coefficient k of about 0.3 W/m²K and thus provide high heat damping. As a result a heat damping layer 5 is produced around the interior 2 of the washing container 1 which holds the thermal energy built up during the washing operation in the washing container 1 substantially in the interior 2 of the washing container 1.

This effect is shown by the arrows A and B in FIG. 1: during washing operation thermal energy is built up by electrical heating means in the interior 2 of the washing container 1 and tends to penetrate outwards from the washing container 1 as a result of the temperature difference from the cooler surroundings of the washing container 1, which is indicated by the arrow A. As a result of the high heat damping of the heat damping layer 5 adjusted to a low thermal conductivity coefficient k of about 0.3 W/m²K, however the thermal energy is substantially reflected at the wall of the washing container 1, which is shown by the arrow B, and thus remains in the washing container 1. In this way, the thermal energy built up during the washing process is held in the washing container 1 and thus the energy requirement of the dishwasher according to the invention is reduced.

FIG. 2 shows a further sectional view of the dishwasher with variable heat damping layer shown in FIG. 1 during drying operation. During the drying phase, the variable heat damping layer 5 is adjusted by means of the hydrogen technology described above so that it has a high thermal conductivity coefficient k of about 10 W/m²K and therefore exhibits no heat damping or only low heat damping. As a result, the thermal energy built up in the washing container 1 is delivered from the interior 2 through the inner wall 3 of the washing container 1 to the surroundings of the dishwasher.

This effect is shown in the arrows A, B and C in FIG. 2: during the washing operation, thermal energy is built up in the interior 2 of the washing container 1 by electrical heating means and tends to penetrate outwards from the washing container 1 as a result of the temperature difference from the cooler surroundings of the washing container 1, which is indicated by the arrow A. As a result of the low heat damping of the heat damping layer 5 adjusted to a high thermal conductivity coefficient k of about 10 W/m²K, however the thermal energy is substantially delivered through the wall of the washing container 1 outwards to the surroundings, which is indicated by the arrow C. Only a small portion of the thermal energy is reflected from the wall of the washing container 1 which is indicated by the arrow B and thus remains in the washing container 1.

In this way, the thermal energy present in the washing container 1 is removed from the washing container 1 during the drying process and is delivered to the surroundings. As a result, the inner wall 3 of the washing container 1 has a lower temperature than the moist warm air located in the interior 2 of the washing container 1, which has the result that the moisture contained in the air is deposited on the inner wall 3 of the washing container 1. This condensation brings about a reduction in the air humidity of the air located in the interior 2 of the washing container 1 which accelerates the drying of the washed items and thus improves the drying process of the dishwasher according to the invention as a whole.

Since the outer walls of the dishwasher (not shown) generally consist of metal, these are especially well suited as cooling surfaces. By producing good heat-conducting contact between the variable heat damping layer 5 and the outer wall of the washing container 1, this ensures effective removal of heat from the inner wall 3 of the washing container 1 through the variable heat damping layer 3 and the bitumen layer 4 to the outer wall of the dishwasher and then to the surroundings. The inner wall 3 of the washing container 1 can consist of plastic or it can also be made of a metal sheet, especially aluminium to promote the condensation of the moist warm air located in the washing container during drying operation

### REFERENCE LIST

1 Dishwasher
2 Washing container or interior of washing container
3 Inner wall of washing container 2
4 Bitumen layer
5 Variable heat damping layer
A Direction of heat transfer from the interior of the washing container 2
B Direction of heat reflected into the interior of the washing container 2
C Direction of heat transfer from the washing container 2 into the surroundings

1-18. (canceled)

19. A dishwasher comprising:
at least one washing container for retaining items to be washed, the washing container having a heat damping layer which at least partially surrounds the washing container and the heat damping layer having a variable thermal conductivity in that the heat damping layer can be adjusted between at least a first thermal conductivity value at which thermal conductivity through the heat damping proceeds at a first rate and a second thermal conductivity value at which thermal conductivity through the heat damping proceeds at a second rate different than the first rate.

20. The dishwasher according to claim 19, wherein the variable heat damping layer includes a closed capsule containing hydrogen in which at least one metal hydride grid is arranged, which can form a chemical compound with the hydrogen and thus bind the hydrogen.

21. The dishwasher according to claim 20, wherein the capsule of the variable heat damping layer has a selected one of a pressed glass and a non-pressed glass fibre core that is surrounded by a gastight jacket made of a selected one of a stainless steel sheet and a non-stainless steel sheet.

22. The dishwasher according to claim 20, wherein the capsule of the variable heat damping layer is operable to function at a temperature of at least about 300° C. when heated by a selected one of electrical heating means and non-electrical heating means.

23. The dishwasher according to claim 20, wherein the heat damping layer is configured such that heating of the capsule of the variable heat damping layer has the effect that the hydrogen previously bound in the metal hydride grid is released, the pressure in the capsule of the variable heat damping layer increases, and the thermal conductivity of at least one of the capsule and the entire heat damping layer is increased.

24. The dishwasher according to claim 20, wherein the heat damping layer is configured such that cooling of the capsule of the variable heat damping layer has the effect that the free hydrogen is resorbed with the metal hydride grid in a chemical compound, the pressure in the capsule of the variable heat damping layer drops, and the thermal conductivity of at least one of the capsule and the entire heat damping layer is decreased.

25. The dishwasher according to claim 20, wherein the capsule of the variable heat damping layer has an internal pressure of about 0.01 mbar at room temperature and an internal pressure of about 50 mbar at a temperature of about 300° C.

26. The dishwasher according to claim 19, wherein the thermal conductivity of the variable heat damping layer is continuously adjustable to an arbitrary thermal conductivity value between the first and second thermal conductivity value.

27. The dishwasher according to according to claim 20, wherein the power of the current applied to the electrical heating means can be continuously regulated and thus the thermal conductivity of the variable heat damping layer can be adjusted to any thermal conductivity value approximately in a range between 0.3 W/m²K and 10 W/m²K.

28. The dishwasher according to claim 19, wherein the variable heat damping layer is in heat-conducting contact with a wall of the washing container and with an outer wall of the dishwasher.

29. The dishwasher according to claim 19, wherein the variable heat damping layer is disposed in a selected one of a side wall and a door of the dishwasher.

30. The dishwasher according to claim 19, wherein the variable heat damping layer is disposed in a selected one of the top and the bottom of the dishwasher.

31. The dishwasher according to claim 19, wherein a wall of the washing container bounding the interior of the washing container is at least partially configured as a condensing surface made of flexible material, comprising at least one of a plastic film, a metal film having a selected one of an aluminium component and a non-aluminum component, and a material that is not a plastic film or a metal film.

32. A method for cleaning and drying items that have been disposed in a dishwasher, the dishwasher having at least one washing container for retaining items to be washed, the washing container having a heat damping layer which at least partially surrounds the washing container and the heat damping layer having a variable thermal conductivity in that the heat damping layer can be adjusted between at least a relatively lower thermal conductivity value at which thermal conductivity through the heat damping proceeds at a first rate and a relatively higher thermal conductivity value at which thermal conductivity through the heat damping proceeds at a second rate higher than the first rate, the dishwasher having a heat generating means for generating heat in the washing container, and the dishwasher being operable to execute at least one washing program comprising the following steps, the method comprising the steps of:
in coordination with the execution of a first section of a washing program during which thermal energy is built up in the washing container by the heat generating means, disposing the heat damping layer at the relatively lower thermal conductivity value such that the thermal energy built up in the washing container is substantially preserved in the washing container; and
in coordination with the execution of a second section of the washing program during which a drying process is carried out, disposing the heat damping layer at the relatively higher thermal conductivity value such that at least some of the thermal energy present in the washing container succeeds to the surroundings via the heat damping layer.

33. The method according to claim 32, wherein before or during a washing process, a clear rinsing process or during a first section of the drying process the variable heat damping layer is adjusted to a low thermal conductivity and thermal energy is built up in the washing container by heat generating means, and during the drying process or during the second section of the drying process the variable heat damping layer is adjusted to a high thermal conductivity.

34. The method according to claim 32, wherein the thermal conductivity of the variable heat damping layer is regulated by the program control of the dishwasher.

35. The method according to claim 32, wherein the thermal conductivity of the variable heat damping layer is regulated preferably by electric heating means used to heat the variable heat damping layer.

36. The method according to claim 32, wherein water deposited during the drying process in the washing container is passed from the washing container via at least one of discharge via a sump of the dishwasher, discharge via a discharge pump, and discharge via a means other than a sump or a discharge pump of the dishwasher.
